(19) United States
(12) Patent Application Publication
(10) Pub. No.: US 2012/0169736 A1
(43) Pub. Date: Jul. 5, 2012

(54) METHODS, APPARATUSES AND COMPUTER PROGRAM PRODUCTS FOR PROVIDING A TRUE RESOLUTION OF GRAPHICS DISPLAYED ON DEVICES

(75) Inventors: Kenneth L. Wells, Decatur, GA (US); Brad Wiederholt, Johns Creek, GA (US); Christian Herrick, Cumming, GA (US)

(73) Assignee: McKesson Financial Holdings Limited

(21) Appl. No.: 12/984,203

(22) Filed: Jan. 4, 2011

(51) Int. Cl. G06T 17/00

(52) U.S. Cl. 345/428

(57) ABSTRACT

An apparatus is provided for enabling graphics to be displayed by one or more devices at the resolution defined for the graphics. The apparatus includes at least one memory and a processor configured to convert data of a graphic(s) in response to receipt of an indication that visible indicia denoting a graphic file(s) associated with the graphic(s) is moved onto a graphical element that is associated with the converted data. The processor is also configured to wrap data of the graphic(s) with an executable to obtain a converted graphic. The executable includes information instructing a device to display the converted graphic exactly, or substantially, at a predefined resolution identified in the executable. The processor is also configured to send the converted graphic to a device(s) that analyzes the executable and displays the converted graphic exactly, or substantially, at the predefined resolution. Corresponding computer program products and methods are also provided.

### TECHNOLOGICAL FIELD

Embodiments of the invention relate generally to image processing technology, and more particularly relate to a method, apparatus and computer program product for enabling display of a graphic(s) on one or more devices according to a predefined resolution(s).

### BACKGROUND

Existing and future technologies continue to facilitate information transfer and convenience to users. Given the prevalence of electronic devices, a large number of individuals are utilizing electronic devices to communicate with each other and share content. One area in which there is a demand to increase ease of information transfer relates to improving a users ability to view graphics.

At present, in some instances, graphics may not be displayed at the resolution in which the graphics were designed. In this regard, for example, when a graphic(s) is provided to an electronic device and viewed, the resolution of the graphics may be different from the resolution intended by a designer of the graphic. The change in the resolution of the graphic may be undesirable since the designer may desire the graphic to have particular visual effects associated with the resolution defined by the designer.

For instance, when generating creative visualizations and digital sketches associated with graphics during a development stage, for example, there may be a desire by a user to determine the manner in which graphics may look when displayed. In this regard, the user may provide these graphics to one or more recipients for feedback, input and approval prior to further work being performed with respect to the graphics. However, a problem may arise when the recipient receives and opens the graphics because a monitor of the recipient, in some instances, may automatically readjust the resolution of the graphics to maximize use of the settings and size of the monitor. As such, the recipient may be inadvertently misled about the visual size in which the graphics may be displayed or viewed based on the recipient's review of the graphics during the development stage. The recipient may send these conceptual draft graphics to others for feedback, input and approval. However, the originally designed graphics may be altered between communication links without anyone realizing that appearance of the graphics changed from the time in which they were originally designed.

If the graphics are approved during a development stage without a true view of the visual size of the graphics, hundreds if not thousands of hours of work may be performed without a recipient of the graphics realizing that he/she approved of graphics, during a development stage, that may appear visually different from what the recipient expects once the graphics are finalized. Additionally, another drawback may relate to a lack of clarity in that the recipient may be unaware that the size of the graphics changed since a previous time that the recipient approved the graphics.

Furthermore, when the original graphics sent to the recipient for review are returned to the designer or creator, the display of the graphics on the monitor of the designer may be the same as it was originally, which may create confusion when the finalized graphics that may be delivered to the recipient may not be the same visual size. These drawbacks and problems may cause confusion and frustration for users dealing with graphics. Additionally, rework associated with modifying graphics to a level of satisfaction may be burdensome for users.

As an example of the foregoing problems and drawbacks, consider FIGS. 1A-1F. In FIG. 1A, a graphics developer or designer may generate one or more artistic renderings to illustrate the manner in which a finished interactive experience may look when displayed in the form of one or more static graphics 2 to represent one or more screens of an actual software production. In FIG. 1B, a graphic file 6 associated with these graphics 2 may be sent to a recipient such as a reviewer in a workspace (e.g., a different computer) in a same building as the developer, or even miles away from the developer in another part of the world by sending the graphic files 2 to the reviewer via email. In FIG. 1C, the reviewer may receive the graphics 2 associated with the graphic file 6 via email and may approve the graphics 2 with delight and may request that a corresponding project associated with the graphics 2 move into actual production. The reviewer may be misled because the reviewer viewed the graphics 2 in a program that automatically resizes images for maximum use of the monitor of the reviewer. As shown in FIG. 1C, the graphics 2 may be displayed at a larger size on the screen of the monitor than what the developer had designed for and because it may not be obvious, neither party may be aware of this event. In other words, neither the reviewer nor the developer may be aware that the size of the graphics 2 is larger than the size of the graphics 2 designed by the developer (See e.g., FIG. 1A).

In FIG. 1D, the developer may also be pleased that the reviewer has approved the designs of the graphics 2. As such, the developer may begin actual production work by writing code and generating links to production graphics 4 in the format that works best with a corresponding software architecture. In the example of FIG. 1D, production has begun on a browser based application. After a significant period of effort and time, the developer may generate a production version for the reviewer to examine. In FIG. 1E, the developer may send a hyperlink 5 of a corresponding web address or Uniform Resource Locator (URL) to a device of the reviewer to show work in progress. In FIG. 1F, the reviewer may analyze the actual product progress related to the production graphics 4 and may be disappointed that the corresponding project seems to have changed since the size of the graphics (e.g., production graphics 4) are significantly different from the size of the graphics (e.g., graphics 2) that were previously approved by the reviewer (See e.g., FIG. 1C). As such, both the developer and the reviewer may continue to be confused about this change in size of the graphics because it may not be obvious since the developer and the reviewer may not see the graphics 2 and production graphics 4 sent to the reviewer seen side-by-side.

In view of the foregoing problems and drawbacks, it may be beneficial to provide a mechanism to enable one or more electronic devices to display graphics according to one or more defined resolution(s) of the graphics.

### BRIEF SUMMARY

A method, apparatus and computer program product are therefore provided that may enable an exemplary embodiment to convert one or more original graphics by dragging or moving visible indicia (e.g., an icon) denoting the graphic(s) onto a graphical representation (e.g., an icon) of a converter module. The converter module may correspond to a true resolution graphic module. The converter module may wrap the data of the graphic(s) with an executable (e.g., a self running executable) to generate a new type of graphic file associated with the graphic(s). In this regard, the converter module may convert data of the original graphic(s) to obtain a converted graphic(s).

The executable may include information in the data of the converted graphic(s) instructing a device to display the graphic(s) exactly, or substantially, at a predefined resolution identified in the information of executable. As such, in this wrapped format, the converted graphic(s) may be displayed at the true resolution predefined for the graphic(s) on a display or monitor and devices may be unable to adjust or resize the converted graphic(s) when the converted graphic(s) is displayed. In this regard, the creator or designer of one or more graphics of an example embodiment may not need to wonder about the designed graphics being displayed at an adjusted resolution or size.

In one exemplary embodiment, a method for enabling graphics to be displayed by one or more devices at the resolution defined for the graphics is provided. The method may include converting data of at least one graphic in response to receipt of an indication that visible indicia denoting at least one graphic file associated with the graphic is moved onto a graphical element that is associated with the conversion of the data. The method may further include enabling wrapping of the data of the graphic with an executable to obtain a converted graphic. The executable may include information instructing a device to display the converted graphic exactly, or substantially, at a predefined resolution identified in the information of the executable. The method may further include enabling sending of the converted graphic to at least one device that may analyze the instructions of the executable and displays the converted graphic exactly, or substantially, at the predefined resolution.

In another exemplary embodiment, an apparatus for enabling graphics to be displayed by one or more devices at the resolution defined for the graphics is provided. The apparatus may include a memory and a processor configured to cause the apparatus to enable conversion of data of at least one graphic in response to receipt of an indication that visible indicia denoting at least one graphic file associated with the graphic is moved onto a graphical element that is associated with the conversion of the data. The processor is further configured to cause the apparatus to enable wrapping of the data of the graphic with an executable to obtain a converted graphic. The executable may include information instructing a device to display the converted graphic exactly, or substantially, at a predefined resolution identified in the information of the executable. The processor is further configured to cause the apparatus to enable sending of the converted graphic to at least one device that may analyze the instructions of the executable and displays the converted graphic exactly, or substantially, at the predefined resolution.

In another exemplary embodiment, a computer program product for enabling graphics to be displayed by one or more devices at the resolution defined for the graphics is provided. The computer program product includes at least one computer-readable storage medium having computer-executable program code instructions stored therein. The computer-executable program code instructions may include program code instructions configured to convert data of at least one graphic in response to receipt of an indication that visible indicia denoting at least one graphic file associated with the graphic is moved onto a graphical element that is associated with the conversion of the data. The computer program product may further include program code instructions configured to enable wrapping of the data of the graphic with an executable to obtain a converted graphic. The executable may include information instructing a device to display the converted graphic exactly, or substantially, at a predefined resolution identified in the information of the executable. The computer program product may further include program code instructions configured to enable sending of the converted graphic to at least one device that may analyze the instructions of the executable and displays the converted graphic exactly, or substantially, at the predefined resolution.

An embodiment of the invention may provide a better user experience since a user may feel comfortable that graphics designed by the user may be displayed by one or more devices according to the predefined resolution established for the graphics without allowing adjustment of the visual sizes of the graphics. As a result, device users may enjoy improved capabilities with respect to graphics.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1A illustrates a diagram of graphics shown on a monitor;

FIG. 1B illustrates a diagram of a graphic file being sent to a device;

FIG. 1C illustrates a diagram of graphics shown on another monitor of a device;

FIG. 1D illustrates a diagram of production graphics shown on a monitor;

FIG. 1E illustrates a diagram of a hyperlink corresponding to a web address or URL being sent to a device;

FIG. 1F illustrates a diagram of production graphics shown on a monitor of a device;

FIG. 2 is a schematic block diagram of a system according to an exemplary embodiment of the invention;

FIG. 3 is a schematic block diagram of a communication device according to an example embodiment of the invention;

FIG. 4 is a schematic block diagram of a computing device according to an exemplary embodiment of the invention;

FIG. 5 is a diagram of a display of one or more generated graphics according to an exemplary embodiment of the invention;

FIG. 6 is a diagram of a display of one or more graphics being exported according to an exemplary embodiment of the invention;

FIG. 7 is a diagram of a display of a graphical representation of a True Viewer Converter according to an exemplary embodiment of the invention;

FIG. 8 is a diagram of a display of one or more graphics files being moved or dragged onto a graphical representation of the True Viewer Converter according to an exemplary embodiment of the invention;

FIG. 9 is a diagram of a display of a dialog box generated in response to graphics files being moved or dragged onto a graphical representation of the True Viewer Converter according to an exemplary embodiment of the invention;

FIG. 10 is a diagram of a display of a new graphics file generated by the True Viewer Converter according to an exemplary embodiment of the invention;

FIG. 11A is a diagram of a display illustrating sending of a new graphics file generated by the True Viewer Converter according to an exemplary embodiment;

FIG. 11B is a diagram illustrating that the new graphics file generated by the True Viewer Converter is delivered to or received by the device according to an exemplary embodiment;

FIG. 11C is a diagram of display of graphics associated with the new graphics file according to an exemplary embodiment of the invention;

FIG. 11D is a diagram of a display for generating a message to send to a device according to an exemplary embodiment of the invention;

FIG. 11E is a diagram of a message including a link associated with one or more production graphics related to the new graphics file according to an exemplary embodiment of the invention;

FIG. 11F is a diagram of a display showing the production graphics associated with the new graphics file according to an example embodiment of the invention; and

FIG. 12 is a flowchart of an exemplary method for enabling one or more graphics to be displayed by one or more devices at the resolution defined for the graphics according to an exemplary embodiment.

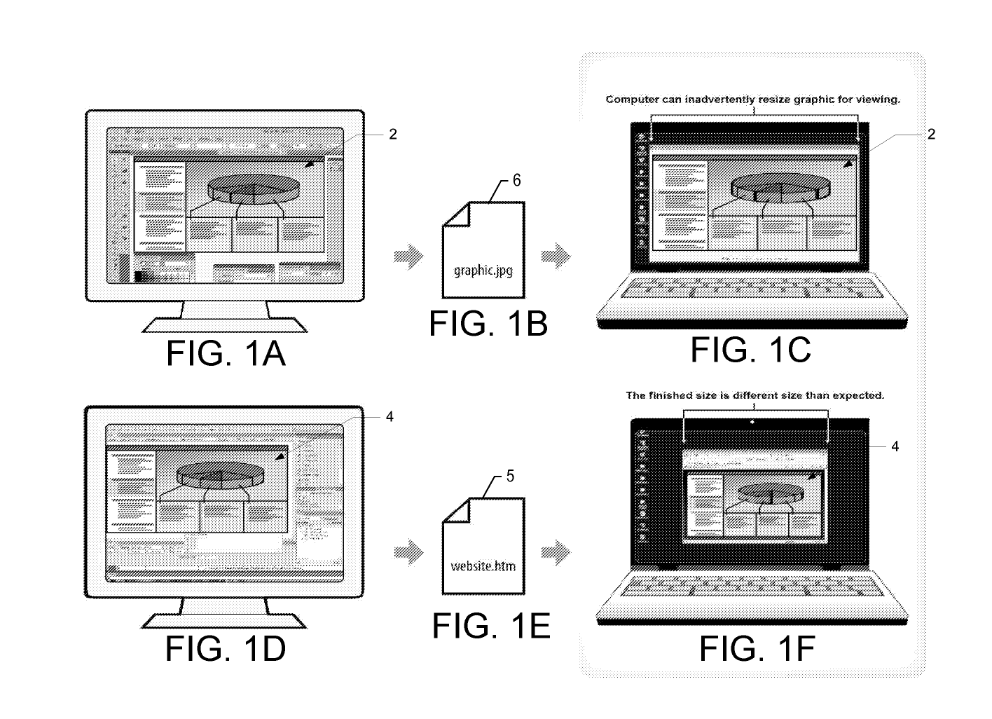

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, the term graphic, graphics or the like may refer to digital data (e.g., digital images, animations, videos, or the like) that may be depicted and displayed by one or more devices.

As referred to herein, the term resolution, resolutions or the like may refer to a size of a graphic(s) and/or width and/or height dimensions of a graphic(s) to be displayed or viewed according to one or more pixels.

As referred to herein, a self running executable(s) may, but need not, refer to an application (e.g., software application), a file (e.g., an executable file) or the like that does not require an install (e.g., a desktop install) by a host device or external player for implementing functions and may run directly with a host operating system (e.g., Windows XP, etc.).

### General System Architecture

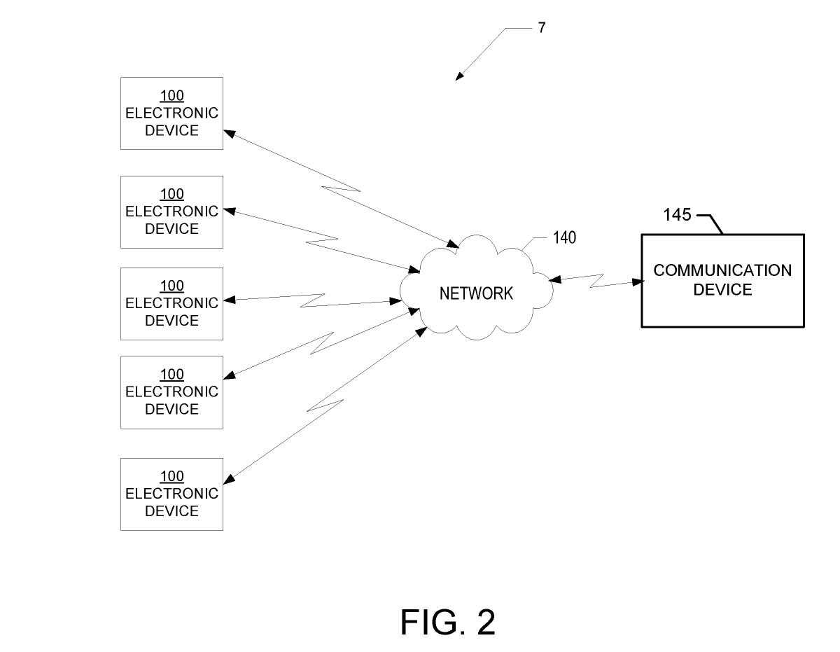

Reference is now made to FIG. 2, which is a block diagram of a system according to an exemplary embodiment. As shown in FIG. 2, the system 7 may include one or more electronic devices 100 (e.g., personal computers, laptops, workstations, personal digital assistants, smart devices and/or the like, etc.) which may access one or more entities such as, for example, a communication device 145 (e.g., a workstation, a smart device, a server, a personal computer, a laptop computer, etc.), or any other similar entity, over a network 140, such as a wired local area network (LAN) or a wireless local area network (WLAN), a metropolitan network (MAN) and/or a wide area network (WAN) (e.g., the Internet). In one example embodiment, the communication device 145 may, but need not, be a network entity. In this regard, the communication device 145 is capable of receiving data from and transmitting data to the electronic devices 100 via network 140. In one exemplary embodiment, the electronic devices 100 may be utilized by one or more individuals that review graphics designed by a designer(s). The electronic devices 100 may also be utilized by any suitable individuals.

It should be pointed out that although FIG. 2 shows five electronic devices 100, one network 140 and one communication device 145, any suitable number of electronic devices 100, networks 140 and communication devices 145 may be part of the system of FIG. 2 without departing from the spirit and scope of the invention.

### Communication Device

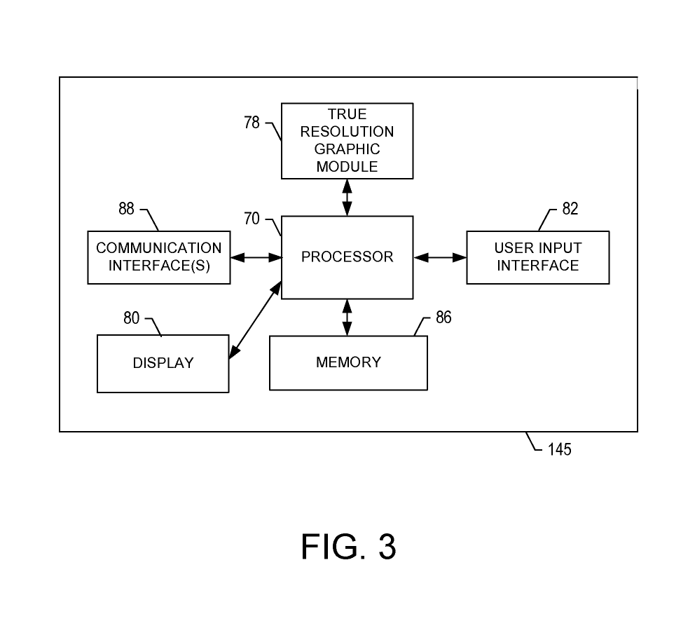

FIG. 3 illustrates a block diagram of a communication device according to an exemplary embodiment of the invention. As described above, the communication device 145 may, but need not, be a workstation, a smart device, a personal computer, a laptop computer, or any other suitable computing device. In one example embodiment, the communication device 145 may be a network device, including but not limited to a server.

The communication device 145 includes various means for performing one or more functions in accordance with exemplary embodiments of the invention, including those more particularly shown and described herein. It should be understood, however, that one or more of the communication devices may include alternative means for performing one or more like functions, without departing from the spirit and scope of the invention. More particularly, for example, as shown in FIG. 3, the communication device 145 may include a processor 70 connected to a memory 86. The memory may comprise volatile and/or non-volatile memory, and typically stores content (e.g., media content), data, information or the like.

For example, the memory may store content transmitted from, and/or received by, one or more of the electronic devices 100. In an exemplary embodiment, the memory 86 may store data associated with one or more graphic files and corresponding graphics. The graphic files may, but need not, correspond to one or more Graphic Interchange Files (GIFs), Joint Photographic Experts Group (JPEG) files, Portable Network Graphic (PNG) files and any other suitable graphics files.

Also for example, the memory 86 typically stores client applications, instructions, algorithms or the like for execution by the processor 70 to perform steps associated with operation of the communication device in accordance with embodiments of the invention. As explained below, for example, the memory 86 may store one or more client applications such as for example software (e.g., software code also referred to herein as computer code).

The processor 70 may be embodied in a variety of ways. For instance, the processor 70 may be embodied as a controller, coprocessor microprocessor of other processing devices including integrated circuits such as, for example, an application specific integrated circuit (ASIC), a field programmable gate array (FPGA). In an exemplary embodiment, the processor may execute instructions stored in the memory 86 or otherwise accessible to the processor 70.

The communication device 145 may include one or more logic elements for performing various functions of one or more client applications. In an exemplary embodiment, the communication device 145 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other devices such as, for example, one or more of the electronic devices 100 over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface can support a wired connection with the respective network.

In addition to the communication interface(s), the interface(s) may also include at least one user interface that may include one or more earphones and/or speakers, a display 80, and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control a true resolution graphic (TRG) module 78 (also referred to herein as True Viewer Converter 78). The TRG module 78 may be any means such as a device or circuitry operating in accordance with software or otherwise embodied in hardware or a combination of hardware and software thereby configuring the device or circuitry (e.g., a processor or controller) to perform the corresponding functions of the TRG module 78, as described below. In examples in which software is employed, a device or circuitry (e.g., processor 70 in one example) executing the software forms the structure associated with such means. As such, for example, the TRG module 78 may be configured to, among other things, convert one or more original graphic files to a new file type by wrapping the graphic files with an executable (e.g., self running executable) to enable the corresponding graphics of the graphic files to be displayed by one or more devices (e.g., electronic devices 100) at the resolution predefined for the corresponding graphics, as described more fully below. The executable (e.g., self running executable) may include data (e.g., instructions (e.g., computer instructions, computer code, etc.)) instructing a device (e.g., electronic device 100) to display the corresponding graphics at the predefined resolution (e.g., a resolution of 1024×768 pixels) identified in the executable. In this regard, the corresponding device may be unable to resize or adjust the size of corresponding graphics associated with the converted graphic files.

The data instructing the device to display the corresponding graphics may, but need not, specify that the graphics are to be displayed exactly at the predefined resolution. Alternatively, the data instructing the device to display the corresponding graphics may specify that the graphics are to be displayed substantially at the predefined resolution (e.g., within a 1%, 2%, 3%, etc. tolerance of the predefined resolution). In one alternative example embodiment, the executable (e.g., self running executable) may, but need not, include data instructing the device not to readjust the visual size or resolution of the graphics when displaying the graphics but rather display the graphics at the predefined resolution.

### Computing Device

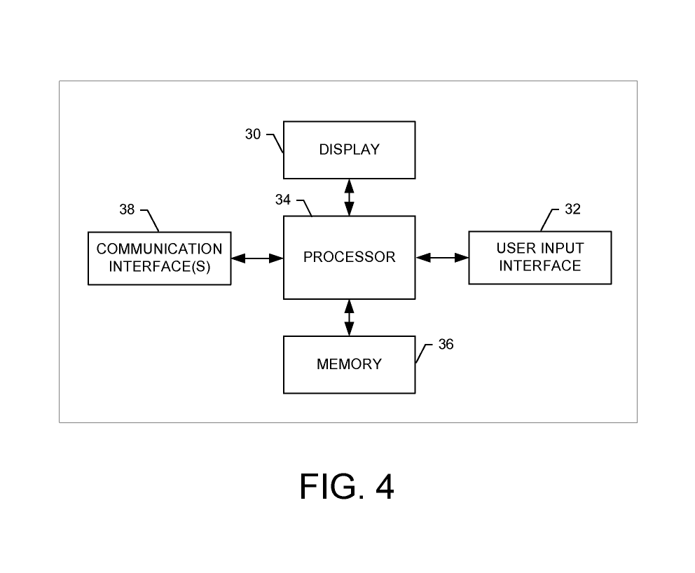

Referring now to FIG. 4, a block diagram of a computing device according to an exemplary embodiment is provided. The computing device is capable of operating as any of electronic devices 100. In this regard, the electronic devices 100 may comprise the elements of the computing device of FIG. 4. As shown in FIG. 4, the computing device may include a processor 34 connected to a memory device 36. The memory device 36 (also referred to herein as memory 36) may comprise volatile and/or non-volatile memory, and may store content, information, data or the like. For example, the memory device 36 typically stores content transmitted from, and/or received by, the computing device. Additionally, the memory device 36 may store client applications, software (e.g., software code, computer code or the like) algorithms, instructions or the like for the processor 34 to perform steps associated with operation of the computing device.

The processor 34 may be connected to at least one communication interface 38 or other means for displaying, transmitting and/or receiving data, content, information or the like. In this regard, the communication interface 38 may be capable of connecting to one or more networks (e.g., network 140). The computing device may also include at least one user input interface 32 that may include one or more speakers, a display 30, and/or any other suitable devices. For instance, the user input interface 32 may include any of a number of devices allowing the computing device to receive data from a user, such as a keyboard, a keypad, mouse, a microphone, a touch screen display, or any other input device.

### Exemplary System Operation

Exemplary embodiments of the invention may provide an efficient and reliable mechanism for enabling one or more devices to display one or more graphics exactly, or substantially, at a predefined resolution. In this regard, the devices may be unable to adjust or resize corresponding graphics in an instance in which the graphics may be displayed. As such, a user (e.g., designer) of the graphics may be assured that the graphics may be viewed by other individuals according the resolution defined by the user (e.g., designer).

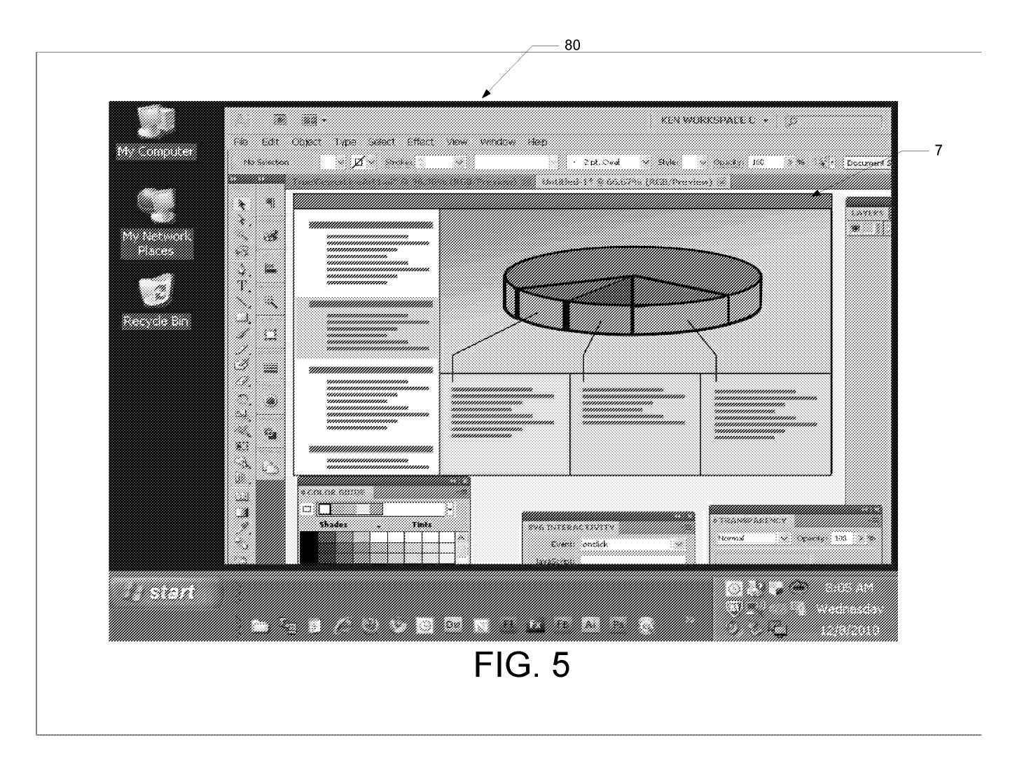

Referring now to FIG. 5, an example embodiment of one or more generated graphics is provided. In the example of FIG. 5, the one or more graphics 7 may be generated by the processor 70 and/or by the TRG module 78 of the communication device 145. In one example embodiment, the graphics 7 may be generated based in part on the processor 70 and/or TRG module 78 receiving inputs provided by a user such as, for example, a designer or a developer of the graphics 7. In the example of FIG. 5, the graphics 7 may be static. However, in an alternative example embodiment, the graphics 7 may be dynamic without departing from the spirit and scope of the invention. Additionally, in the example embodiment of FIG. 5, the graphics 7 may, but need not, correspond to one more JPEG images. However, in another alternative example embodiment, the graphics 7 may correspond to any other suitable images, including but not limited to, GIF images, PNG images or the like.

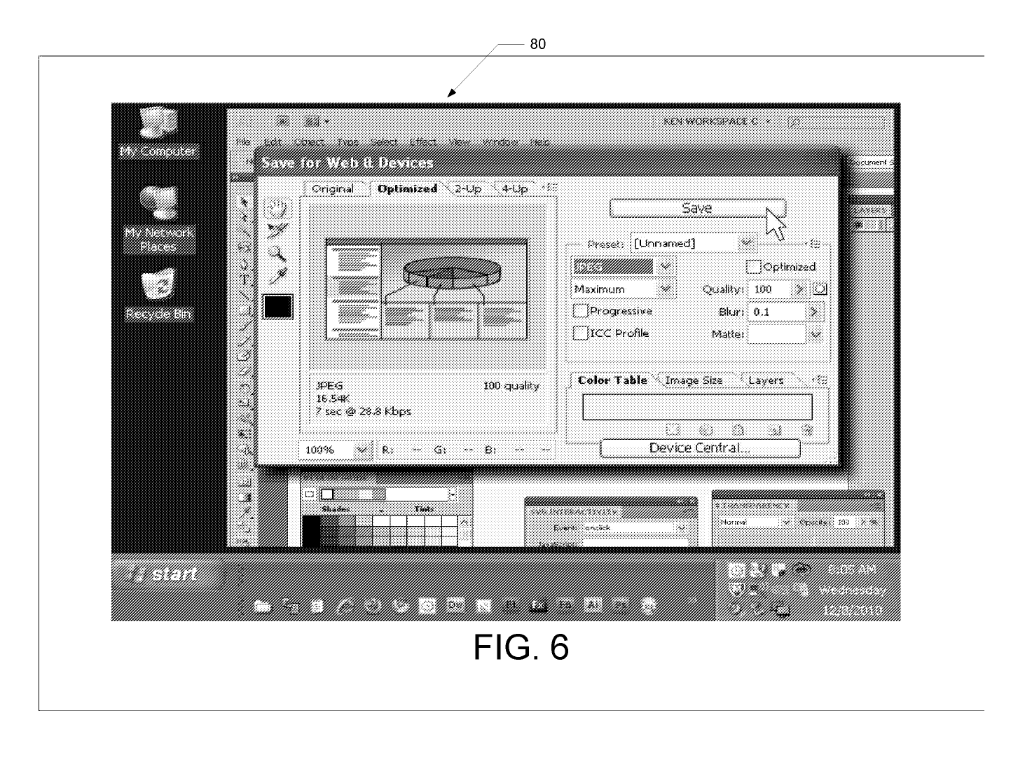

The graphics 7 may correspond to one or more artistic renderings designed by a user such as, for example, a developer, to illustrate the manner in which a finished interactive experience may look by examining the graphics 7 being displayed by display 80 to represent one or more screens of an actual software production. In the example of FIG. 6, a processor (e.g., processor 70) of the communication device 145 may receive a selection to export one or more graphics files. The exported graphics files may be associated with the graphics 7. In the example of FIG. 6, the exported graphics files may correspond to JPEG files or any other suitable files (e.g., PNG files, GIF files).

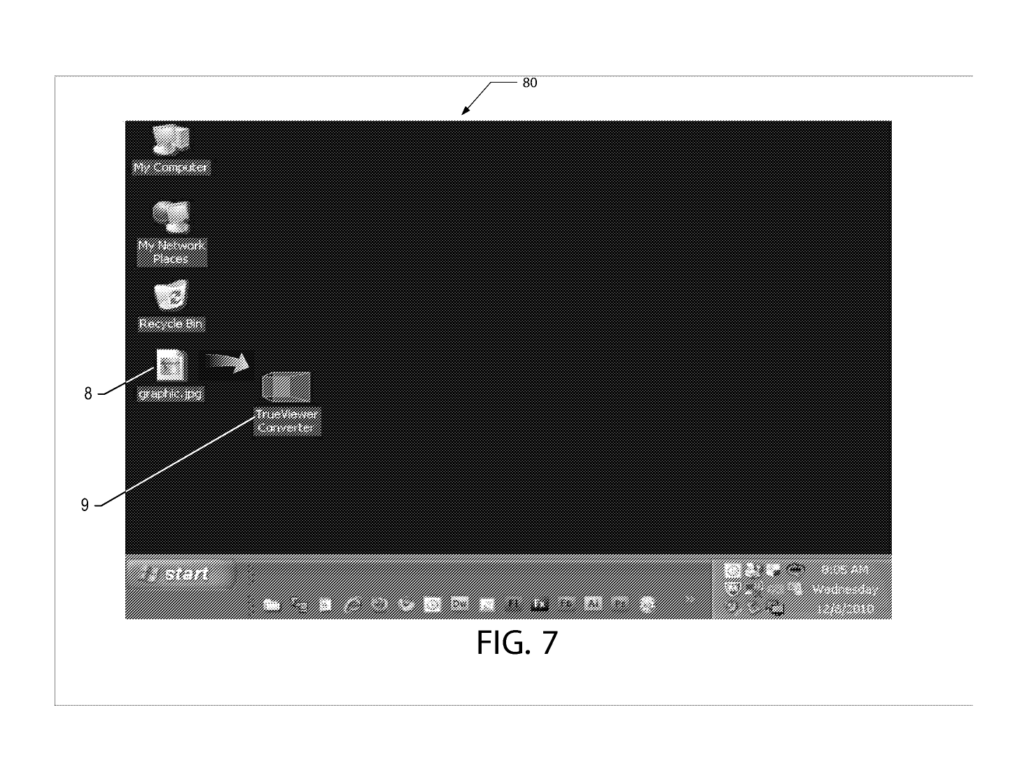

Referring now to FIG. 7, a diagram illustrating a graphical representation of a True Viewer Converter is provided. The graphical representation 9 (also referred to herein as visible indicia 9) of the True Viewer Converter may correspond to an icon or the like that graphically represents the TRG module 78. The graphical representation 9 of the True Viewer Converter may be shown on a display 80 of the communication device 145. Visible indicia (e.g., an icon) denoting the graphics file 8 associated with the graphics 7 may also be shown displayed on the display 80.

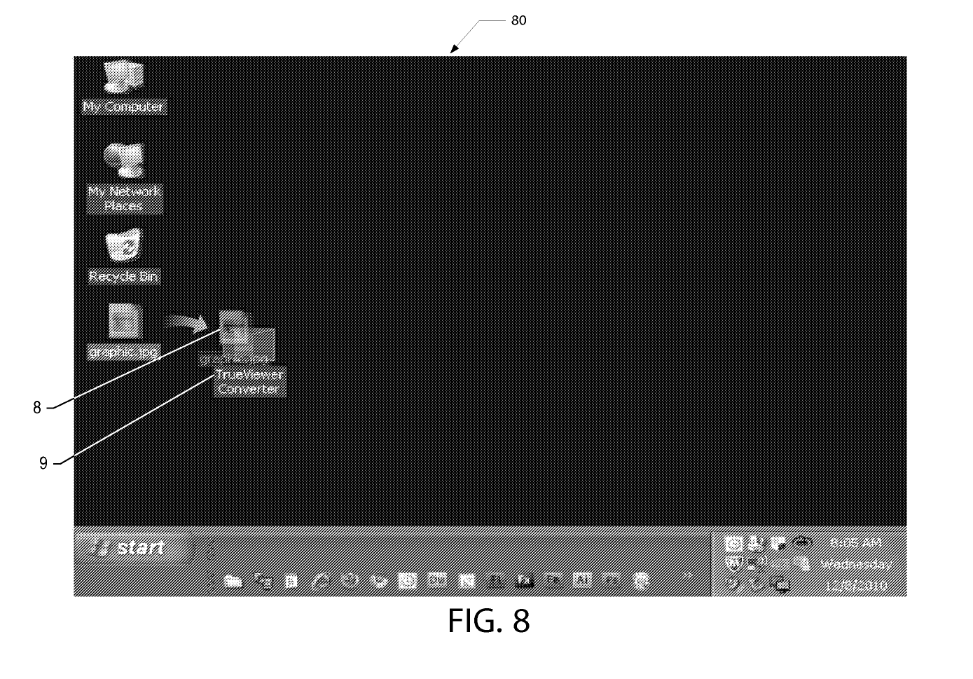

Referring now to FIG. 8, an illustration of the graphics file 8 being dragged or moved onto the graphical representation 9 of the True Viewer Converter is provided. In response to receipt of an indication that the visible indicia of the graphics file 8 is moved or dragged onto the graphical representation 9 of the True Viewer Converter, the TRG module 78 may be triggered to convert the graphics file 8 to a type of new file, as described more fully below.

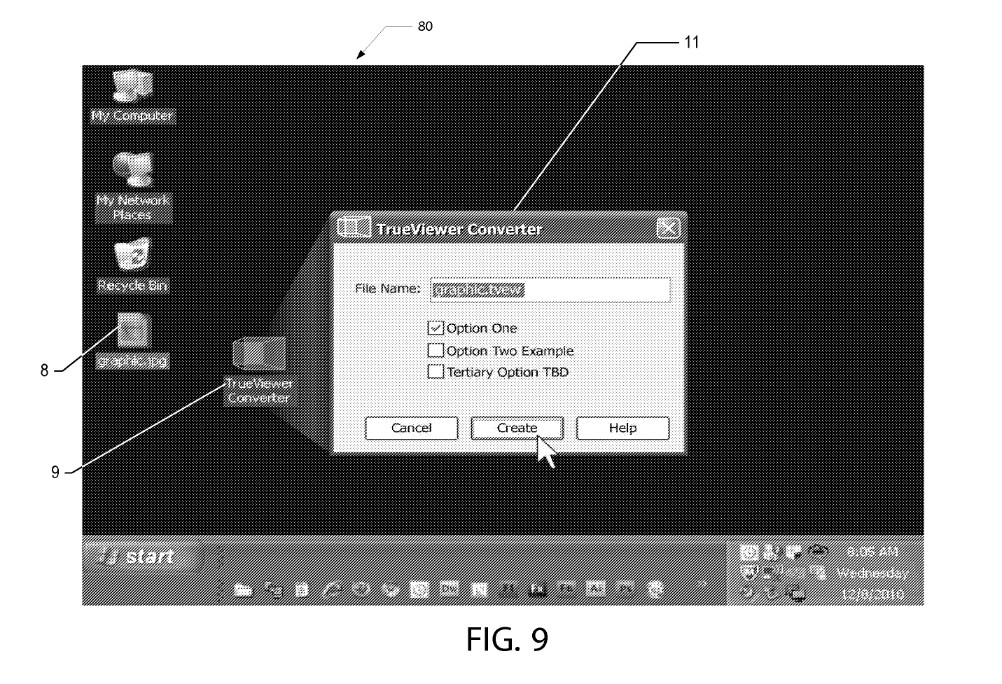

Referring now to FIG. 9, an illustration of a dialog box generated by the TRG module 78 in response to receipt of an indication that one or more graphics files (e.g., graphics file 8) are moved or dragged onto the graphical representation 9 of the True Viewer Converter is provided. In the example of FIG. 9, the TRG module 78 may generate the dialog box 11 in response to receipt of an indication that the visible indicia denoting the graphics file 8 was moved onto the graphical representation 9 of the True Viewer Converter. In this regard, the dialog box 11 may include a field to rename a previously assigned name of the graphics file 8 to a new file for a conversion of the graphics 7 by the TRG module 78. The dialog box 11 may also include other options. In the example of FIG. 9, the TRG module 78 may receive indications, via data input by a user (e.g., a developer), that the new name corresponds to “graphic.tvew”. In response to receipt of a selection of a create button, the TRG module 78 may convert the graphics file 8, and its associated graphics 7, to a type of new file corresponding to a new extension (e.g., “.tvew”) that may be added to the end of a corresponding name. In this regard, the TRG module 78 may generate a copy of the information (e.g., digital image information) of the original graphics 7 and may wrap the information into an executable (e.g., a self running executable).

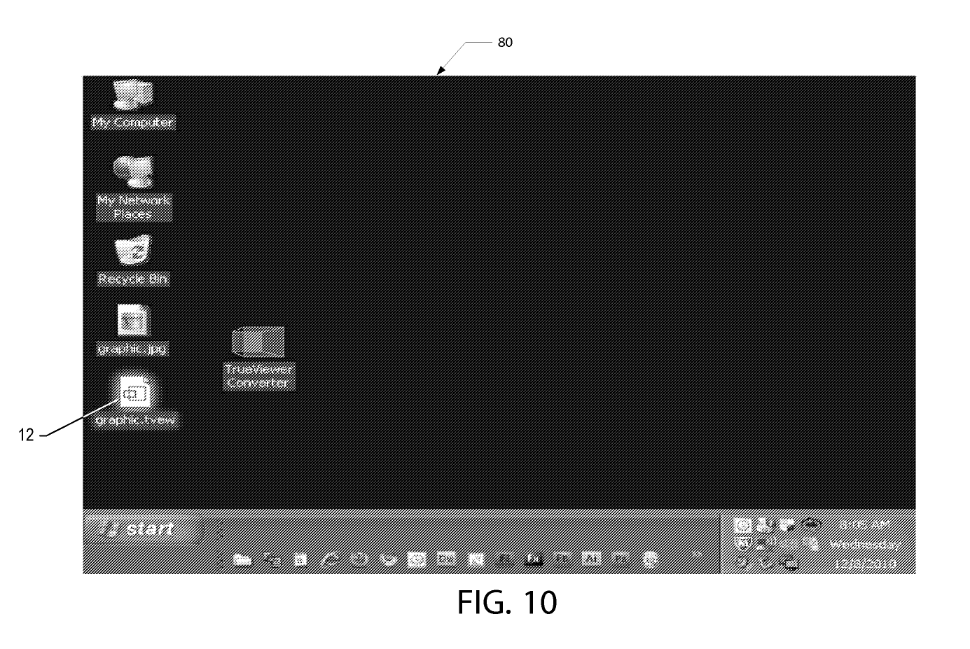

The executable (e.g., self running executable) may include data instructing a device (e.g., electronic device 100) to display the copied graphics 7 exactly, or substantially (e.g., within a predetermined tolerance (e.g., within a predetermined tolerance of 1% of the predefined resolution, etc.), at the resolution (e.g., 1024×768 pixels) defined in data of the executable (e.g., the self running executable). In this regard, the device may be unable to adjust or resize the copy of the converted graphics 7 in an instance in which the device displays the converted graphics 7. In one alternative example embodiment, the executable (e.g., self running executable) generated by the TRG module 78 may, but need not, include data instructing a device not to resize or adjust the graphics associated with the copy of the converted graphics but rather to display the graphics only according the predefined resolution identified in the data of the executable. As shown in FIG. 10, the TRG module 78 may enable display (e.g., via display 80) of the new graphics file 12 associated with the copy of the converted graphics 7. The new graphics file 12 may be associated with the name (e.g., graphic.tvew) assigned by the TRG module 78 in response to receipt of the data input by the user (e.g., a developer).

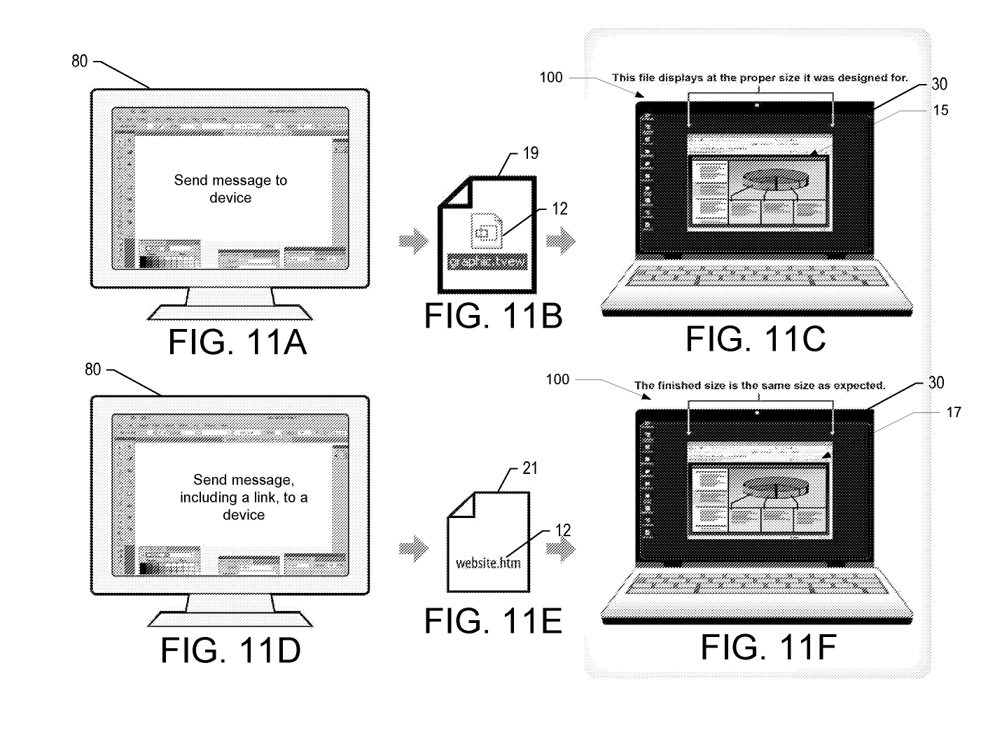

Referring now to FIG. 11A, the TRG module 78 may generate a message for sending the new graphics file 12 to a device (e.g., electronic device 100). In this regard, the TRG module 78 may select the new graphics file 12 associated with a copy of the converted graphics 7 and may include the new graphics file 12 in the message. In the example embodiment of FIG. 11A, the TRG module 78 may send the new graphics file 12 to an electronic device 100 via any suitable messages including, but not limited to, an email message(s), a multimedia messaging service (MMS) message(s), or any other suitable messages. Additionally, in one example embodiment, the TRG module 78 may enable the new graphics file to be downloaded by the electronic device 100 from a website, web server, portal or the like. In the example embodiment of FIG. 11B, the message 19 may include the new graphics file 12 and may be sent by the TRG module 78 to the electronic device 100.

In the example embodiment of FIG. 11C, upon receipt of the new graphics file 12 by the electronic device 100, a processor (e.g., processor 34) of the electronic device 100 may analyze the data of an executable (e.g., an self running executable) of the new graphics file 12 and the processor may enable display (e.g., via display 30) of one or more graphics 15 of new graphics file 12 according to the predefined resolution identified in the data of the executable (e.g., self running executable). In this regard, the electronic device 100 may enable display of the graphics 15 according to a true view of the size as predefined for the graphics 15 associated with the new graphics file 12. In this regard a user (e.g., reviewer of the new graphics file 12) may see a true view of the size and resolution of the graphics 15 as predefined by the TRG module 78, for example. The TRG module 78 may predefine the resolution based on input received by the TRG module 78 from a user such as, for example, a designer. In one example embodiment, a user (e.g., a reviewer) may approve of the graphics 15 and may utilize the electronic device 100 to send a message to the TRG module 78 indicating that graphics 15 are approved.

It should be pointed out that the processor of the electronic device 100 may analyze the data of the executable (e.g., the self running executable) associated with the new graphics file 12 in response to receipt of an indication of a selection of the new graphics file 12. For instance, a user (e.g., a reviewer) may open the new graphics file 12 by utilizing a finger, pointing device or the like of the user input interface 32 to double click (or right click) the new graphics file 12. Additionally, a user (e.g., a reviewer) may select the new graphics file 12 of message 19 and save the new graphics file 12 to a memory (e.g., memory 36) of the electronic device 100. The new graphics file 12 may not automatically open in other applications being executed by the processor of electronic device 100. In this regard, the TRG module 78 may prohibit one or more applications (e.g., unauthorized applications) of a device (e.g., electronic device 100) from opening the graphics 15 of the new graphics file 12 for display. Instead, in one example embodiment, the new graphics file 12 may open upon execution by the TRG module 78 of a corresponding application (e.g., an authorized application (e.g., a true viewer converter application)). It should be pointed out that the graphics 15 of the new graphics file 12 may correspond to a copy of the converted graphics 7.

In an example embodiment, the TRG module 78 may extract a copy of the graphics file 8 (e.g., also referred to herein as original graphics file 8) from the new graphics file 12, in response to receipt of a selection of an indication to extract the original graphics file 8. The selection may be in response to a user selecting (e.g., right clicking) the new graphics file 12 and selecting an option, in a pop up menu or the like, for example, to unwrap the new graphics file 12. In response to receipt of the selection to unwrap the new graphics file 12, the TRG module 78 may generate a copy of the original graphic file 8 and may also maintain/retain the new graphics file 12. The copy of the original graphic file 8 generated by the TRG module 78 may be stripped or removed of the executable (e.g., the self running executable) that was wrapped to the new graphics file 12. As such, the copy of the original graphics file 8 may not include any enhancements that may be provided by the TRG module 78.

By creating the copy of the original graphics file 8, the electronic device 100 may facilitate storage of the original graphics file 8 and the new graphics file 12 in a memory (e.g., memory 36) of the electronic device 100.

Referring now to FIG. 11E, the TRG module 78 may generate a message including a link corresponding to production graphics. The production graphics may be associated with the new graphics file 12. For instance, the production graphics may, but need not, correspond to a modified version(s) of the graphics 15. The modified versions of the graphics 15 may relate to finalizing a work in progress associated with the graphics 15. As referred herein, a modified version(s) of the graphics 15 may also be referred to herein as modified converted graphics. For purposes of illustration and not of limitation, a user (e.g., a developer or designer of graphics) may perform additional work on the graphics 15 in response to receipt of an indication from the electronic device 100 that the graphics 15 were approved. The graphics 15 may be approved by a user (e.g., reviewer) in the manner described above. The TRG module 78, may send the link to a device (e.g., electronic device 100) in any suitable manner such as, for example, by sending a message(s), including but not limited to, an email message(s), a MMS message(s) or any other suitable message(s). The TRG module 78 may also enable download of the production graphics by an electronic device 100 via a web server, website, portal, or the like or in any other suitable manner.

As shown in FIG. 11E, the message 21, including the link 14 associated with the production graphics may be sent by the TRG module 78 to an electronic device 100. The link 14 may be associated with a website, a website address, a hyperlink, a URL, or the like. As shown in FIG. 11F, the electronic device 100 may receive the production graphics 17 sent by the TRG module 78 and the processor (e.g., processor 34) of the electronic device 100 may enable display of the production graphics 17. Since the production graphics 78 may correspond to a modified version of a finalized work in progress of the graphics 15, the production graphics 17 may include the executable (e.g., the self running executable) that may have data instructing the processor (e.g., processor 34) of the electronic device 100 to display the production graphics 17 at the predefined resolution identified in the data of the executable. In this regard, the processor of the electronic device 100 may enable display of the production graphics 17 at the predefined resolution assigned for the production graphics 17 which may correspond to the predefined resolution of the graphics 15.

As such, a user (e.g., a reviewer) may view the production graphics 17 at the same size and resolution of graphics 15. In this regard, the user (e.g., a reviewer) may be pleased with the production graphics 15 since a size and resolution of the production graphics 17 may be the same as the graphics 15 that were previously approved by the user (e.g., a reviewer). In one example, embodiment, a user (e.g., a reviewer) may utilize the electronic device 100 to send the TRG module 78 a message indicating that the production graphics are approved.

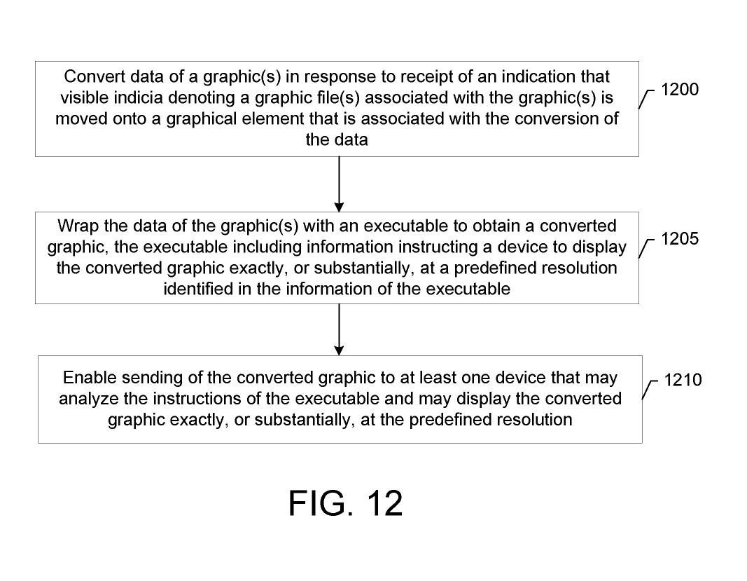

Referring now to FIG. 12, a flowchart of an exemplary method for enabling one or more graphics to be displayed by one or more devices at the resolution defined for the graphics is provided. At operation 1200, an apparatus (e.g., communication device 145) may convert data of at least one graphic (e.g., graphics 7) in response to receipt of an indication that visible indicia denoting at least one graphic file associated with the graphic(s) is moved onto a graphical element that is associated with the conversion of the data. In one example embodiment, the visible indicia may correspond to a graphical representation or a graphical element (e.g., an icon (e.g., the visible indicia or graphical element associated with graphic file 8)) depicting the graphic file. In one example embodiment, the graphical element may correspond to the graphical representation 9 of the True Viewer Converter which may be associated with the TRG module 78.

At operation 1205, an apparatus (e.g., communication device 145) may wrap the data of the at least one graphic (e.g., graphics 7) with an executable to obtain a converted graphic (e.g., graphics 15). The executable may include information instructing a device (e.g., electronic device 100) to display the converted graphic exactly, or substantially, at a predefined resolution identified in the information of the executable. In one example embodiment, displaying the converted graphic substantially at the predefined resolution may include displaying the converted graphic within a predetermined threshold (e.g., within a 1% tolerance, within a 2% tolerance, within a 3% tolerance, etc.) of the predefined resolution.

At operation 1210, an apparatus (e.g., communication device 145) may enable sending of the converted graphic to at least one device (e.g., an electronic device 100) that may analyze the instructions of the executable (e.g., a self running executable) and may display the converted graphic exactly, or substantially, at the predefined resolution identified in the information of the executable.

It should be pointed out that FIG. 12 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86, memory 36) and executed by a processor (e.g., processor 70, processor 34, TRG module 78). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the methods of FIG. 12 above may comprise a processor (e.g., the processor 70, the processor 34, the TRG module 78) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 70, the processor 34 (e.g., as means for performing any of the operations described above), the TRG module 78 and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
converting data of at least one graphic in response to receipt of an indication that visible indicia denoting at least one graphic file associated with the graphic is moved onto a graphical element that is associated with the conversion of the data;
enabling wrapping, via a processor, of the data of the graphic with an executable to obtain a converted graphic, the executable comprising information instructing a device to display the converted graphic exactly, or substantially, at a predefined resolution identified in the information of the executable; and
enabling sending of the converted graphic to at least one device that analyzes the instructions of the executable and displays the converted graphic exactly, or substantially, at the predefined resolution.

2. The method of claim 1, further comprising:
determining that substantially comprises enabling display of the converted graphic within a predetermined threshold of the predefined resolution.

3. The method of claim 1, further comprising:
automatically triggering the conversion of the data in response to receipt of an indication that the graphic is moved onto the graphical element.

4. The method of claim 1, wherein prior to converting the data the method further comprises:
automatically generating a dialog box to assign a new file type to the graphic in response to the receipt of the indication, and
wherein the executable comprises a self running executable.

5. The method of claim 1, further comprising:
enabling unwrapping of the data of the graphic to generate a copy of the graphic that does not comprise the executable in response to receipt of a selection,
wherein unwrapping comprises retaining a version of the converted graphic.

6. The method of claim 1, further comprising:
enabling display of the converted graphic on the basis of the instructions of the executable; and
prohibiting one or more applications of the at least one device from opening the converted graphic for display.

7. The method of claim 1, further comprising:
modifying the converted graphic to obtain a modified converted graphic that comprises the executable, the executable comprises additional information instructing the device to display the modified converted graphic exactly, or substantially, at the predefined resolution; and
enabling sending of the modified converted graphic to the at least one device that analyzes the additional information and displays the modified converted graphic exactly, or substantially, at the predefined resolution.

8. The method of claim 2, wherein:
the executable comprises additional information instructing the device not to display the converted graphic at a resolution different from the predefined resolution or at a resolution that is not within the predetermined threshold; and
wherein the converted graphic may comprise content relating to at least one of one or digital images, one or more animations, or one or videos.

9. An apparatus comprising:
at least one memory; and
at least one processor configured to cause the apparatus to:
enable conversion of data of at least one graphic in response to receipt of an indication that visible indicia denoting at least one graphic file associated with the graphic is moved onto a graphical element that is associated with the conversion of the data;
enable wrapping of the data of the graphic with an executable to obtain a converted graphic, the executable comprising information instructing a device to display the converted graphic exactly, or substantially, at a predefined resolution identified in the information of the executable; and
enable sending of the converted graphic to at least one device that analyzes the instructions of the executable and displays the converted graphic exactly, or substantially, at the predefined resolution.

10. The apparatus of claim 9, wherein the processor is further configured to cause the apparatus to:
determine that substantially comprises enabling display of the converted graphic within a predetermined threshold of the predefined resolution.

11. The apparatus of claim 9, wherein the processor is further configured to cause the apparatus to:
automatically trigger the conversion of the data in response to receipt of an indication that the graphic is moved onto the graphical element.

12. The apparatus of claim 9, wherein prior to the conversion of the data, the processor is further configured to cause the apparatus to:
automatically generate a dialog box to assign a new file type to the graphic in response to the receipt of the indication, and
wherein the executable comprises a self running executable.

13. The apparatus of claim 9, wherein the processor is further configured to cause the apparatus to:
enable unwrapping of the data of the graphic to generate a copy of the graphic that does not comprise the executable in response to receipt of a selection,
wherein unwrapping comprises retaining a version of the converted graphic.

14. The apparatus of claim 9, wherein the apparatus is further configured to cause the apparatus to:
enable display of the converted graphic on the basis of the instructions of the executable; and
prohibit one or more applications of the at least one device from opening the converted graphic for display.

15. The apparatus of claim 9, wherein the apparatus is further configured to cause the apparatus to:
modify the converted graphic to obtain a modified converted graphic that comprises the executable, the executable comprises additional information instructing the device to display the modified converted graphic exactly, or substantially, at the predefined resolution; and
enable sending of the modified converted graphic to the at least one device that analyzes the additional information and displays the modified converted graphic exactly, or substantially, at the predefined resolution.

16. The apparatus of claim 10, wherein:
the executable comprises additional information instructing the device not to display the converted graphic at a resolution different from the predefined resolution or at a resolution that is not within the predetermined threshold; and
wherein the converted graphic may comprise content relating to at least one of one or digital images, one or more animations, or one or videos.

17. A computer program product comprising at least one computer-readable storage medium having computer-executable program code instructions stored therein, the computer executable program code instructions comprising:
program code instructions configured to convert data of at least one graphic in response to receipt of an indication that visible indicia denoting at least one graphic file associated with the graphic is moved onto a graphical element that is associated with the conversion of the data;
program code instructions configured to enable wrapping of the data of the graphic with an executable to obtain a converted graphic, the executable comprising information instructing a device to display the converted graphic exactly, or substantially, at a predefined resolution identified in the information of the executable; and
program code instructions configured to enable sending of the converted graphic to at least one device that analyzes the instructions of the executable and displays the converted graphic exactly, or substantially, at the predefined resolution.

18. The computer program product of claim 17, further comprising:
program code instructions configured to determine that substantially comprises enabling display of the converted graphic within a predetermined threshold of the predefined resolution.

19. The computer program product of claim 17, further comprising:
program code instructions configured to automatically trigger the conversion of the data in response to receipt of an indication that the graphic is moved onto the graphical element.

20. The computer program product of claim 17, further comprising:
program code instructions configured to automatically generate a dialog box to assign a new file type to the graphic in response to the receipt of the indication, and
wherein the executable comprises a self running executable.

21. The computer program product of claim 17, further comprising:
program code instructions configured to enable unwrapping of the data of the graphic to generate a copy of the graphic that does not comprise the executable in response to receipt of a selection,
wherein unwrapping comprises retaining a version of the converted graphic.

22. The computer program product of claim 17, further comprising:
program code instructions configured to enable display of the converted graphic on the basis of the instructions of the executable; and
program code instructions configured to prohibit one or more applications of the at least one device from opening the converted graphic for display.

23. The computer program product of claim 17, further comprising:
program code instructions configured to modify the converted graphic to obtain a modified converted graphic that comprises the executable, the executable comprises additional information instructing the device to display the modified converted graphic exactly, or substantially, at the predefined resolution; and
program code instructions configured to enable sending of the modified converted graphic to the at least one device that analyzes the additional information and displays the modified converted graphic exactly, or substantially, at the predefined resolution.
